(19) United States
(12) Patent Application Publication
(10) Pub. No.: US 2009/0144666 A1
(43) Pub. Date: Jun. 4, 2009

(54) METHOD AND APPARATUS FOR IMPROVING USER EXPERIENCE WHEN READING A BIDI DOCUMENT

(76) Inventors: Qi Lu, Beijing (CN); Lin Xie, Beijing (CN); Jin Zhu, Beijing (CN); Zhi Bo Zuo, Beijing (CN)

Correspondence Address: HOFFMAN WARNICK LLC, 75 STATE STREET, 14TH FLOOR, ALBANY, NY, 12207, US

(21) Appl. No.: 12/274,550

(22) Filed: Nov. 20, 2008

(30) Foreign Application Priority Data
Nov. 22, 2007 (CN) 200710186842.0

(51) Int. Cl. G06F 3/048

(52) U.S. Cl. 715/859; 715/862

(57) ABSTRACT

A method and apparatus for improving user experience when reading a BiDi document is provided. The method comprises the steps of: receiving the range of a specific text content the reading direction of which needs to be indicated in the BiDi document; determining the reading direction of the specific text content; and displaying a direction flag for the specific text content to indicate the reading direction of the specific text content. The method and apparatus enable a user to know the correct reading direction of a specific text content in a BiDi document conveniently and intuitively, thus improving user experience when the user reads the BiDi document, and avoiding possible misunderstanding and consequences.

### TECHNICAL FIELD

The present invention relates to the computer field, particularly to the field of editing and displaying documents (particularly electric documents), and more particularly to a method and apparatus for improving user experience when reading bi-directional text (abbreviated as BiDi) document.

### BACKGROUND ART

Currently most written languages in the world such as those which use Latin letters like English and modern Chinese are written in a direction from left to right (LTR). But there also exist a small number of written languages such as Arabic and Hebrew languages which are written in a direction from right to left (RTL). When an LTR text and an RTL text mix in a piece of text, each type of text should be written in its own direction, thus forming a bi-directional text (abbreviated as BiDi) document.

A computer system having a BiDi support capability can display texts of different languages on a same page correctly regardless of whether the writing directions of these languages are identical.

Unicode Standard Annex #9, which can be obtained from unicode.org, provides a basis for complete BiDi support. The standard specifies detailed rules on how to code and display an LTR and RTL mixed text. In the Unicode coding, all characters are stored in the writing order, while it is determined by software in what direction a text is to be displayed on a page or screen. Thus, all computer systems complying with the Unicode standard will be able to display texts from different languages correctly in a same script, regardless whether the writing directions of the texts are identical.

However, the BiDi rules are very complex, and the rules implemented by different software are usually not unified. When the same script contains two or more kinds of texts having different writing directions, when texts having different writing directions refer to each other or even refer in a multi-layer way, and when a BiDi document contains such special texts as dates, numbers, formulae etc., it will become especially complicated. In addition, while the BiDi algorithm in Unicode is a universal algorithm, this algorithm does not take into account some special habits of some people who speak the Hebrew or Arabic language. Take equations as an example. For the Hebrew language, although its words are from right to left, its equations are from left to right. For people who speak the Arabic language, the use of equations has two cases: when using Arabic numerals (1, 2, . . . ), the direction of the equation is from left to right, whereas when using the so-called Indian numbers, the direction of the equation is from right to left.

For example, FIG. 1 illustrates the displaying of a Hebrew text and Arabic text containing equations by three types of common software. As shown in the figure, the same equation is displayed in different directions among the texts of different languages in different software. This will cause a misunderstanding very easily for a user who is not familiar with both Hebrew and Arabic languages, and this kind of misunderstanding can bring about a serious consequence. For example:

For the following formula:

$$\frac{8 x - 8}{3 x + 2}$$

Assuming x=2, if the direction of the formula is from left to right, then its value is 1; and if its direction is from right to left, then its value is −1. In fact, all equations containing other mathematical symbols such as “/” will face this issue.

This situation will bring about great inconvenience to those who need to deal with BiDi texts but are not familiar with Hebrew language and/or Arabic language. For example, in education, students who are there to learn the BiDi rules may get puzzled. Writers of technical documents encountering various languages in their routine work may not always know what the correct BiDi rules, thus affecting the work. Globalization verification testers may have problems when testing BiDi texts since they do not know the BiDi algorithm clearly. For another example, an employee of a company having trade relations with various countries worldwide may receive orders from various countries such as Arabic or Hebrew ones, and these orders may have some expressions or equations for computing total prices or discounts. In Arabic orders, both Arabic text and expressions or equations are from right to left; and in Hebrew orders, Hebrew text is from right to left, while Hebrew expressions or equations are from left to right. When the employee reads these two kinds of orders, the employee might get confused.

The current software focuses on how to display a BiDi text correctly, and this problem has been essentially solved. But there still exists a problem of how to enable a user to determine a correct reading direction conveniently and correctly.

### SUMMARY OF THE INVENTION

The present invention provides a solution for clearly displaying the correct reading direction of specific content such as an equation in a BiDi document, thus improving user experience when reading a BiDi document.

According to one aspect of the present invention, there is provided a method for improving user experience when reading a BiDi document, comprising: receiving a range of a special text content a reading direction of which needs to be indicated in the BiDi document; determining the reading direction of the special text content; and displaying a direction flag for the special text content to indicate the reading direction of the special text content.

According to the second aspect of the present invention, there is provided an apparatus for improving user experience when reading a BiDi document, comprising: a special text content range receiving module for receiving a range of a special text content a reading direction of which needs to be indicated in the BiDi document; a reading direction determining module for determining the reading direction of the special text content; and a direction flag displaying module for displaying a direction flag for the special text content to indicate the reading direction of the special text content.

The present invention can improve user experience when a user reads a BiDi document, enables users who are not familiar with the language and display rules of the BiDi document to know the correct reading directions of the special text contents in the BiDi document conveniently, thus avoiding possible misunderstanding and serious consequences possibly caused thereby.

### BRIEF DESCRIPTION OF THE DRAWINGS

The attached claims describe novel features believed to be characteristic of the present invention. However, the invention itself and its various embodiments, additional objects, and advantages can be best understood from the following detailed description of the illustrative embodiments when read in conjunction with the drawings.

FIG. 1 illustrates the displaying of an Arabic text and a Hebrew text both containing an equation by three kinds of common software.

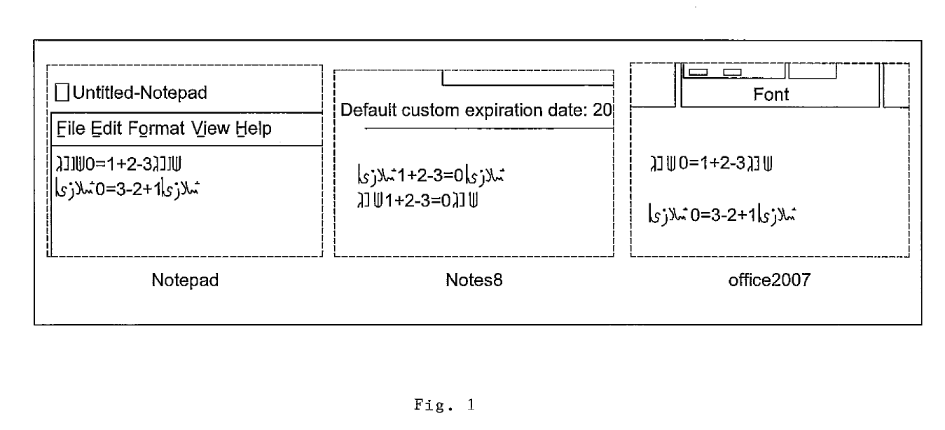

FIG. 2 illustrates several implementations of a method for marking the reading direction of a specific text content in a BiDi document by using an arrow according to an embodiment of the present invention.

FIG. 3 shows a method for improving user experience when reading a BiDi document according to an embodiment of the present invention.

FIG. 4 shows an apparatus for improving user experience when reading a BiDi document according to an embodiment of the present invention.

### DETAILED DESCRIPTION OF THE INVENTION

The present invention provides a method for improving user experience when reading a BiDi document. In accordance with the present invention, when a user reads a BiDi document, for a specific text content in the BiDi document, such as a formula, a direction flag indicating the reading direction of the specific text content is displayed, thus allowing the user to determine the reading direction of the formula conveniently and easily, thus improving the user experience when the user reads the BiDi document.

The direction flag can be of various formats. For example, the direction flag may comprise an arrow. The arrow can be one of any format. For example, the arrow line may have any color, line width, line type (solid line, dotted line, single line, double line, etc.), and the arrowhead may have various shapes, sizes and fillings. The arrow may also be a highlighted colored arrow. The arrow may have either a color identical to that of the BiDi text, or a color different from that of the BiDi text, so as to be more eye-catching. The color of the arrow may be any color and may have different gray scales.

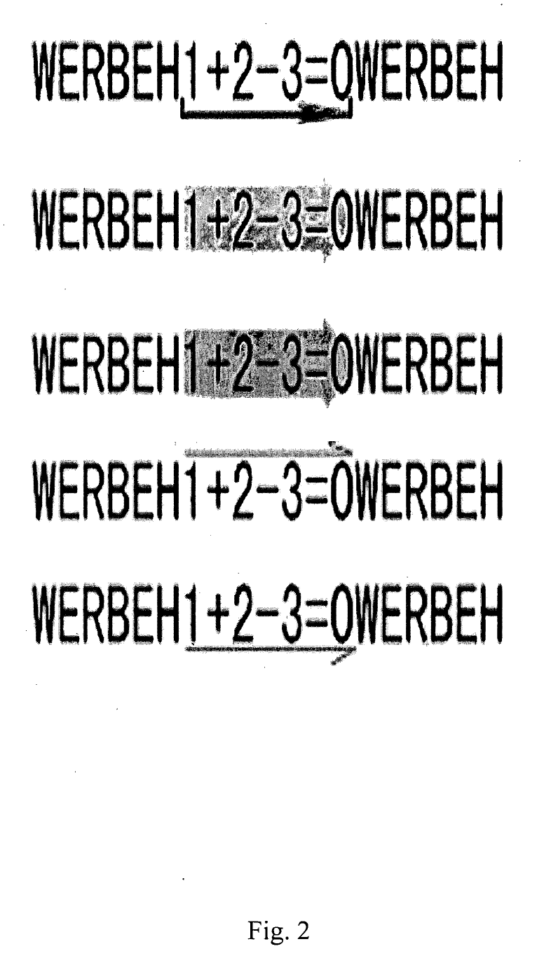

FIG. 2 illustrates several implementations of a method for marking the reading direction of a specific text content in a BiDi document by using an arrow according to an embodiment of the present invention. As shown in FIG. 2, in a first exemplary implementation of the method (1), the direction arrow 10₁ is marked under a formula in the BiDi document, where the direction arrow 10 is a full arrow, the arrow line is a single line, and there are two short vertical lines at two ends of the arrow for marking the application range of the arrow, i.e., the formula. In the second exemplary implementation of the method (2), the direction arrow 10₂ is a highlighted colored arrow, the arrow overlaps with the formula in the BiDi document the direction of which needs to be indicated, and its width is wide enough to cover the formula, thus clearly showing the application range of the direction arrow. The third exemplary implementation of the method (3) is similar to the second one, and the only difference lies in the color and/or gray scale of the directional arrow 10₃. In the fourth exemplary implementation of the method (4), the direction arrow 10₄ is marked above the formula in the BiDi document, and the arrow is a half arrow with only its upper half remaining. In the fifth exemplary implementation of the method (5), the direction arrow 10₅ is marked under the formula in the BiDi document, and the arrow is a half arrow with its lower half remaining. It should be noted out that the above mentioned method for marking the reading direction of a specific text content in the BiDi document is only an illustration instead of a limitation to the present invention. The present invention can adopt an arrow of any other format such as position, shape, size, color, gray scale etc., or any other direction flag to mark the reading direction of a specific text content in the BiDi document.

In an embodiment of the present invention, the BiDi document is an electric document generated by any editing software running on a computer system, the electric document is stored and distributed, and is displayed by document displaying or reading software running on another computer system. The format of the BiDi document can be any existing or future document format, such as HTML, .doc, .pdf, etc. The BiDi document may be generated by an editing software complying with the Unicode BiDi standard, so the BiDi document contains the universal format codes for correctly displaying the BiDi text content, and thus can be displayed correctly by document displaying or reading software complying with the same Unicode BiDi standard. The BiDi document can also be generated by document editing software which does not comply with the Unicode BiDi standard but complies with a certain proprietary BiDi text coding format, thus the generated BiDi document can be displayed correctly by document displaying or reading software complying with the same BiDi text coding format.

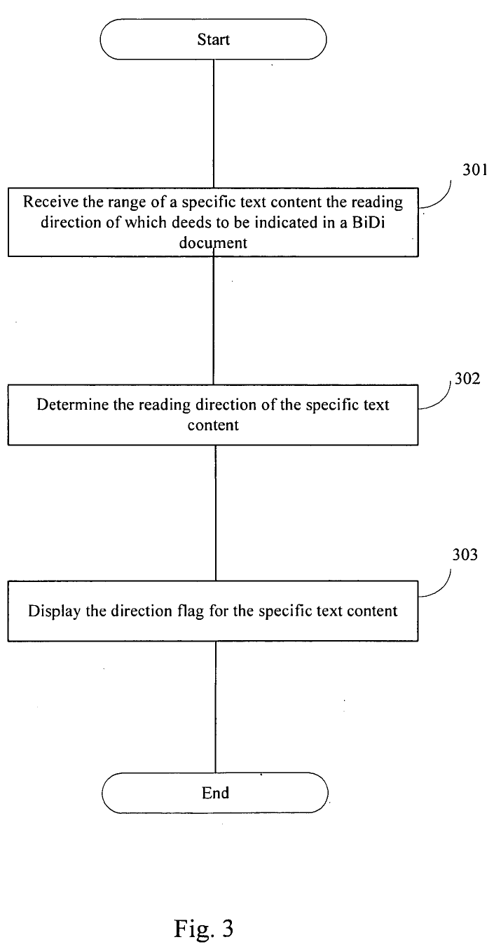

FIG. 3 shows a method for improving user experience when reading a BiDi document according to an embodiment of the present invention. The method will be described below with reference to FIG. 3.

As shown in the figure, at step 301, the range of a specific text content in a BiDi document the reading direction of which needs to be indicated is received. This step may be executed, for example, by document displaying or reading software when loading and displaying the BiDi document. The document displaying or reading software can receive the range of a specific text content the reading direction of which needs to be indicated by using any method known in the art.

In an embodiment of the present invention, when a user creates or edits a BiDi document by using document editing software, the user sets the range of a specific text content in the BiDi document the reading direction of which needs to be indicated, and stores the setting in the BiDi document, thus allowing document displaying or reading software to receive the range of the specific text content in the BiDi document by extracting the setting stored in the BiDi document.

In another embodiment of the present invention, when a user display a BiDi document by using document displaying or reading software, the user specifies the range of a specific text content in the BiDi document the reading direction of which needs to be indicated, so that the document displaying or reading software can receive the range of the specific text content in the BiDi document by receiving the specification of the user.

In a further embodiment of the present invention, the document displaying or reading software may receive the range of a specific text content in the BiDi document the reading direction of which needs to be indicated by searching in the BiDi document using fixed and built-in rules. For example, the document displaying or reading software takes formulae in the BiDi document as specific text contents the reading directions of which need to be indicated according to built-in rules, and identifies formulae the reading directions of which need to be indicated by searching in the BiDi document for characters specific to formulae.

In still another embodiment of the present invention, the document displaying or reading software may receive a range of a specific text content in the BiDi document the reading direction of which needs to be indicated by searching in the BiDi document using a pre-set rule, for example, the indication target setting of a direction flag as described below.

In step 302, the reading direction of the specific text content in the BiDi document is determined. The document displaying or reading software or the document edit software may determine the reading direction of the specific text content by using any method known in the art.

For example, for a BiDi document complying with the Unicode BiDi standard and some other BiDi standards, since the characters in the document are stored in its writing order or logical order, the reading direction of the specific text content is consistent with the order in which the characters in the specific text content are stored in the document. So, in an embodiment of the present invention, the document displaying or reading software may determine the reading direction of the specific text content by determining the order in which the characters in the specific text content are stored in the document.

In a BiDi document complying with some other BiDi document standards, the reading direction of the text content of the BiDi document can not be reflected by the storing order of the characters, instead, it can be determined based on some other rules on the logical orders and storage modes of various text content. To this extent, in another embodiment of the present invention, the document displaying or reading software may determine the reading direction of a specific text content in the BiDi document according to the rules on the logical orders and storage modes of various text contents of the corresponding BiDi document standard.

In another embodiment of the present invention, when a user creates or edits a BiDi document through a document editing software, the user sets the reading direction of a specific text content in the BiDi document, and stores the set reading direction in the BiDi document in association with the corresponding specific text content. Thus, when a user loads and display the BiDi document through the document displaying or reading software, the document displaying or reading software may determine the reading direction of the specific text content by reading the reading direction setting of the specific text content stored in the BiDi document.

In addition, in a further embodiment of the present invention, when a user edits the BiDi document using the document editing software, the user creates a direction flag of specific text content in the BiDi document, and stores the direction flag in the BiDi document in association with the specific text content. In such an embodiment, the step of determining the reading direction of specific text content in a BiDi document is implemented by the document editing software by receiving the designation of the user.

In step 303, a direction flag is displayed for the range of the specific text content received in step 301 according to the reading direction of the specific text content determined in step 302.

In an embodiment of the present invention, the direction flag of a specific text content in a BiDi document is created by the document editing software when creating or editing the BiDi document, and is stored in the BiDi document in association with the specific text content. Thus, when the document displaying or reading software displays the BiDi document, it also reads the direction flag stored in association with the specific text content in the BiDi document, and displays the direction flag in association with the specific text content, so as to indicate the reading direction of the specific text content.

In another embodiment of the present invention, the direction flag of a specific text content in a BiDi document is created and displayed by the document displaying or reading software when displaying the BiDi document.

In an embodiment of the present invention, once the direction flag is created and displayed, it will be displayed along with the BiDi document all the time. For example, for a BiDi document generated in a traditional way, once the direction flag of specific text content therein is written in the document, it will be displayed in the document all the time. For another example, for a BiDi document in an electronic form, whether the direction flag of its specific text content is created by a document editing software when creating or editing the BiDi document or is created by a document displaying or reading software when displaying or reading the BiDi document, the direction flag of its specific text content will be displayed along with the displaying of the BiDi document all the time, thus facilitating the user to read the BiDi document.

In another embodiment of the present invention, only when a user executes a certain action, for example, only when a user moves the cursor of a mouse or an indicator on or near a specific text content in a BiDi document, or only when a user selects a specific text content in a BiDi document or selects a text block containing the specific text content, or only when a user selects a menu item or button to execute a command for displaying direction flags of specific text contents, can the direction flag be displayed.

In an embodiment of the present invention, as described above, the direction flag is displayed near the specific text content, for example, above, under or overlapping partly or completely with the specific text content. In another embodiment of the present invention, when the cursor of a mouse or an indicator moves nearby the specific text content, the direction flag is displayed at the cursor of the mouse or the indicator. In a further embodiment of the present invention, when a cursor of a mouse or an indicator moves nearby the specific text content, the direction flag is displayed on the status bar of a document window of the document displaying or reading software.

Given the appearance, display time, and display position of the direction flag, the direction flag may be created and displayed in a manner known in the art. For example, on a Windows platform, various direction flags such as an arrow can be created and displayed by directly invoking drawing functions of Windows GDI. On other platforms, various direction flags can be created and displayed using their respective drawing functions. In addition, in the present application, the displaying should be construed as also including other outputting and presenting manners such as printing.

In embodiments of the present invention, the specific text content is a formula such as a mathematical formula, or a reference to a text content of another language, or any text content having a reading direction different from that of the text content of the context thereof or being different from that of the text content of the context thereof in any other way.

In an embodiment of the present invention, the attributes of the direction flag such as an indication target (i.e., a rule for determining the specific text content the direction flags of which need to be displayed), appearance, display time, and display position can be set and stored by a user as his/her user preferences. The user may set in his/her displaying or reading software the indication target, appearance, display time, display position, etc., for the direction flag of a specific text content in a BiDi document, and store the settings as user preferences in the software. Thus, whenever the user reads a BiDi document through the displaying or reading software, a direction flag for the corresponding specific text content in the direction flag will be displayed for the user according to one or more of the appearance, display time, and display position of the direction flag settings in the user preferences. Alternatively, the user may also set in his document editing software an indication target, appearance, display time, display position, etc., for the direction flag of the specific text content in a BiDi document when creating or editing the BiDi document, and store the settings as user preferences in the BiDi document or store and distribute the settings in association with the BiDi document. Thus, whenever the BiDi document is displayed or read by the user or another user in a document displaying or reading software, the document displaying or reading software will display a direction flag for the corresponding specific text content in the BiDi document according to one or more of the appearance, display time, display position, and indication target of the direction flag settings received along with the BiDi document.

In the foregoing, a method for improving user experience when reading a BiDi document according to embodiments of the present invention has been described. It should be noted that the above description is only an illustration, instead of a limitation to the present invention. For example, the method for improving user experience when reading a BiDi document of the present invention can have more, less or different steps as compared to what is described, the order of some steps as described can be changed, some steps can be subdivided into smaller steps or merged into greater steps. All of these variations fall within the spirit and scope of the present invention. In addition, while for the convenience of narration, the above description is presented with respect to document displaying or reading software or document editing software, it is obvious for a person skilled in the art that the document displaying or reading software or document editing software can also be substituted with a hardware apparatus having corresponding functions or an apparatus or system formed by a combination of software and hardware having corresponding functions.

The method of the present invention may be implemented by a computer system, which should be construed in a broad sense as comprising any apparatus having a data processing capability, such as a personal computer, workstation, server, PDA, digital reader, etc., and system software such as various OSs, and various application software, including various word processing software, browsers, reading software, etc., having a text processing capability and running on the apparatus. Specifically, a module (for example, contained in a application software such as editing software or reading software) according to the present invention in the computer system executes the method of the present invention by interacting and combining with other application software modules, system software, and device hardware in the computer system such as a processor, memory, display device, etc.

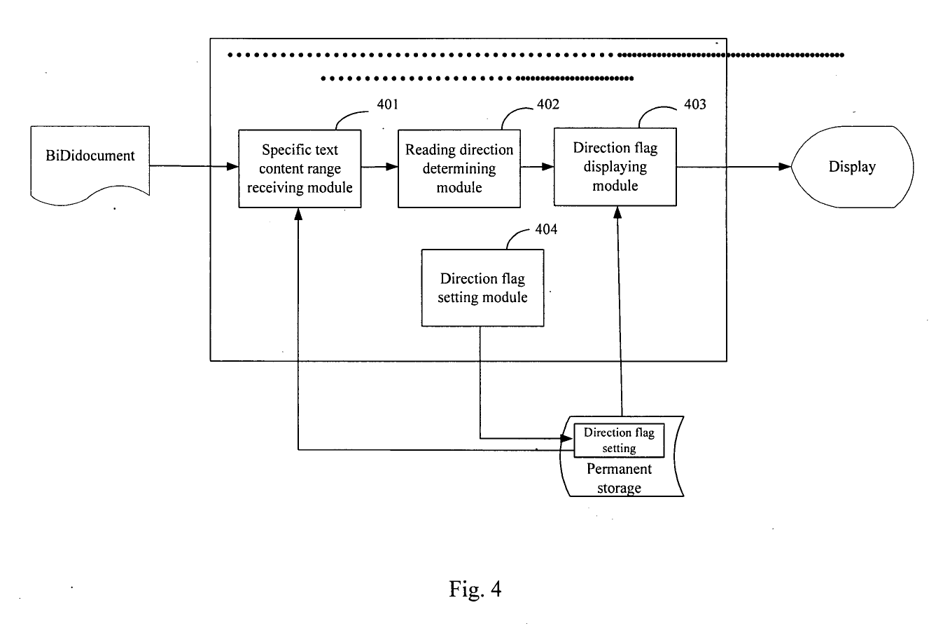

An apparatus according to the present invention will be described below with reference to the drawings. FIG. 4 shows an apparatus for improving user experience when reading a BiDi document according to an embodiment of the present invention. The apparatus may be implemented in a document displaying or reading apparatus or a document editing apparatus, or may be implemented in a document displaying or reading apparatus and a document editing apparatus in a distributed way, in which, the modules in the apparatus are distributed in the document displaying or reading apparatus and the document editing apparatus. The apparatus of the present invention can also be implemented as a standalone apparatus. Thus, the apparatus will cooperate with the document displaying or reading apparatus or the document editing apparatus mutually. The apparatus of the present invention can either be incorporated as an additional module(s) into an existing document displaying or reading apparatus or document editing apparatus or cooperate therewith mutually, or act as part of a new document displaying or reading apparatus or document editing apparatus.

As shown in FIG. 4, in an embodiment of the present invention, the apparatus comprises a specific text content range receiving module 401, a reading direction determining module 402, a direction flag displaying module 403, and an optional direction flag setting module 404.

The specific text content range receiving module 401 is used for receiving the range of specific text contents (such as formulae, references to other languages, etc.) in a BiDi document the reading directions of which need to be indicated.

In an embodiment of the present invention, the specific text content range receiving module 401 searches for the specific text content the reading directions of which need to be indicated according to pre-set rules, such as a setting regarding the indication target of a direction flag in the direction flag settings which are set and stored in advance by the direction flag setting module 404 as described below. For example, if the setting of the indication target includes formula, reference or text of a certain language, etc., then the specific text content range receiving module 401 will search for formulae, reference or text of the language, etc., in the BiDi document, and determine the content searched out as a specific text content the direction flag of which needs to be displayed.

In another embodiment of the present invention, the specific text content range receiving module 401 determines a specific text content in a BiDi document the direction flag of which needs to be displayed according to a built-in and fixed rule. For example, the specific text content range receiving module 401 may search for all the formulae, etc., in a BiDi document, and determine them as the specific text content the direction flag of which needs to be displayed.

In a further embodiment of the present invention, the specific text content the direction flag of which needs to be displayed will be selected or designated by a user when reading the displayed BiDi document, in which case, the specific text content range receiving module 401 can receive the range of the specific text content in the BiDi document the direction flag of which needs to be displayed by receiving the designation of the user.

In still another embodiment of the present invention, the range of the specific text content in a BiDi document the reading direction of which needs to be indicated is set and stored in the BiDi document when the user creates or edits the BiDi document through document editing software. Thus, when the user loads and displays the BiDi document through document displaying or reading software, the specific text content range receiving module 401 may receive the range of a specific text content in the BiDi document the reading direction of which needs to be indicated by extracting the settings stored in the BiDi document. In this embodiment, the apparatus for improving user experience when reading a BiDi document according to the present invention further comprises a module for setting the range of the specific text content in a BiDi document the reading direction of which needs to be indicated so that a user may perform the above setting.

The reading direction determining module 402 is used to determine the reading direction of the specific text content received by the specific text content range receiving module 401. The reading direction of the specific text content is a logical sequential direction or writing direction of the characters in the text content, and in systems complying with the Unicode BiDi standard or some other standards, the reading direction is consistent with the storing and transmitting order of the characters in the BiDi document. So, in systems complying with the Unicode BiDi standard, etc., the reading direction determining module 402 may determine the reading direction of the specific text content according to the storing order of the characters in the specific text content.

In systems complying with other standards, the reading direction determining module 402 may determine the reading direction of the specific text content in the BiDi document according to a rule in the standards regarding the logical order and storage manner of a text content in a BiDi document.

In another embodiment of the present invention, the reading direction of a specific text content in a BiDi document is set by a user when creating or editing the BiDi document through document editing software, and is stored in the BiDi document in association with the corresponding specific text content. Thus when a user loads and displays the BiDi document through document displaying or reading software, the reading direction determining module 402 may determine the reading direction of the specific text content by reading the setting of the reading direction of the specific text content stored in the BiDi document. In this embodiment, the apparatus for improving user experience when reading a BiDi document according to the present invention further comprises a module for setting the reading direction of a specific text content in a BiDi document the reading direction of which needs to be indicated.

In an embodiment of the present invention, the reading direction determining module 402 is implemented in document displaying or reading software. In other embodiments of the present invention, when a user edits a BiDi document through document editing software, the user creates a direction flag of specific text content in the BiDi document, and stores the direction flag in the BiDi document in association with the specific text content. In such an embodiment, the reading direction determining module 402 is implemented in the document editing software, and determines the reading direction of specific text content in the BiDi document by receiving the user's designation.

The direction flag displaying module 403 is used to create and display the direction flag of the specific text content according to the reading direction of the specific text content in the BiDi document as determined by the reading direction determining module 402. For example, if the reading direction determining module 402 determine the reading direction of a specific text content is from left to right, then the direction flag displaying module 403 will create and display a rightward direction flag, otherwise, the direction flag displaying module 403 will create and display a leftward direction flag. The direction flag displaying module 403 can display the created direction flag in the BiDi document displayed in a monitor, or present the created direction flag in the BiDi document output in other output devices such as a printer.

The direction flag displaying module 403 can create any direction flag indicating a reading direction. For example, the direction flag can be an arrow. The arrow can be of any format, for example, the arrow can be any type of line with arrow, e.g., line with specific width, solid line, dotted line etc, and an arrow head having various shapes such as a solid shape, a hollow shape etc. and various filling colors and gray scales. The two ends of the arrow may have short lines indicating its application range. The arrow can be a highlighted colored arrow, which preferably overlaps with part or all of the indicated specific text content.

The direction flag displaying module 403 may create or display the direction flag by using a programming method well known by a person skilled in the art. For example, on a Windows platform, various direction flags such as an arrow can be created and displayed by directly invoking drawing functions in Windows GDI, and on other platforms, various direction flags can be created and displayed by using their respective drawing functions.

The direction flag displaying module 403 can display the created direction flag at various times. In an embodiment of the present invention, the direction flag is created when document displaying or reading software creates or edits the BiDi document, is stored in the BiDi document in association with the corresponding specific text content, and is stored and distributed together with the BiDi document. Thus, when document displaying or reading software displays the BiDi document, it can display the direction flag in association with the specific text content. That is, the direction flag displaying module 403 is implemented in both the document displaying or reading software and the document editing software in a distributed way.

In other embodiments of the present invention, the direction flag displaying module 403 is implemented in the document displaying or reading software centrally, wherein the direction flag displaying module 403 creates and displays the direction flag for the specific text content according to the reading direction of the specific text content in the BiDi document as determined by the reading direction determining module 402. The direction flag displaying module 403 may display the direction flag in the displayed BiDi document permanently, i.e., whenever the BiDi document is displayed and during the entire period that the BiDi document is displayed, the direction flag remains displayed. In addition, the direction flag displaying module 403 can also display the direction flag at specific times, for example, when a user selects specific text content or a text block containing the specific text content or moves a cursor nearby the specific text content, the direction flag for the specific text content is displayed. Alternatively, when the user selects a menu item or clicks a command button, the direction flag displaying module 403 displays the direction flags in all or a selected part of the current BiDi document.

The direction flag displaying module 403 may display a direction flag of a specific text content in a BiDi document at various positions, such as above, under or overlapping all or part of the specific text content. Alternatively, whenever a user moves a cursor nearby specific text content in a BiDi document, the direction flag displaying module may display the direction flag at the cursor or on a status bar of the document window.

In an embodiment of the present invention, the apparatus for improving user experience when reading a BiDi document of the present invention further comprises a direction flag setting module 404 for setting and storing the indication target, appearance, display time, and display position, etc., of a direction flag.

In an embodiment of the present invention, the direction flag setting module 404 resides in document displaying or reading software, and stores the settings regarding direction flags as user preferences in a permanent storage. Thus, when the document displaying or reading software opens and displays any BiDi document, the direction flag displaying module 403 may create and display a direction flag of a corresponding specific text content according to one or more settings such as the indication target, appearance, display time and display position, etc. regarding the direction flag in the user preference.

In another embodiment of the present invention, the direction flag setting module 404 resides in document editing software, and stores the settings regarding the direction flag in a BiDi document or stores and distributes the settings regarding the direction flag in association with the BiDi document. Thus, when the BiDi document is opened or displayed by document displaying or reading software or apparatus of the present invention, the specific text content range receiving module 401 in the apparatus for improving user experience when reading a BiDi document of the present invention in the document displaying or reading software or apparatus creates and displays the direction flag of a corresponding specific text content according to one or more settings such as the indication target, appearance, display time and display position, etc. regarding the direction flag stored in the BiDi document.

The present invention can be implemented in hardware, software or a combination thereof. The present invention can be implemented in a computer system in a centralized mode or in a distributed mode, in which, different parts are distributed in several interconnected computer systems. Any computer system or other apparatus suitable for executing the methods described herein is applicable. A typical combination of hardware and software may be a general-purpose computer system having a computer program, which, when being loaded and executed, controls the computer system to cause it to execute the steps of the method described herein, or constitute the functional modules in the apparatuses or systems according to embodiments of the present invention.

While the apparatus of the present invention has been described above with reference to the drawings, it should be noted that the above description is only an illustration instead a limitation to the present invention. For example, the apparatus may contain more, less or different modules compared to what is described, and each of the modules as described can be partitioned into a plurality of smaller modules which perform its functions together, or the modules as described can be merged into greater modules. All of these variations fall within the spirit and scope of the present invention.

While the present invention is shown and described with reference to the preferred embodiments particularly, a person skilled in the art can understand that various changes in form and detail can be made thereto without departing from the spirit and scope of the present invention.

1. A method for improving user experience when reading a bi-directional (BiDi) document, comprising:
receiving a range of a specific text content a reading direction of which needs to be indicated in the BiDi document;
determining the reading direction of the specific text content; and
displaying a direction flag for the specific text content to indicate the reading direction of the specific text content.

2. The method according to claim 1, wherein the direction flag is an arrow and is displayed above, under, or overlapping with the specific text content.

3. The method according to claim 1, wherein displaying the direction flag further comprises:
displaying the direction flag when a cursor is moved to a position of the specific text content or when the specific text content is selected.

4. The method according to claim 1, wherein when a cursor is near the specific text content, the direction flag is displayed at a position of the cursor or on a status bar of a document window in which the specific text content is displayed.

5. The method according to claim 1, further comprising, before displaying the direction flag:
setting and storing at least one attribute for the direction flag, the attribute comprising at least one of: an indication target, appearance, display time, and display position.

6. The method according to claim 1, further comprising, before receiving the range of a specific text content the reading direction of which needs to be indicated in a BiDi document:
setting the range of the specific text content the reading direction of which needs to be indicated in the BiDi document; and
setting the reading direction of the specific text content.

7. The method according to claim 1, wherein the specific text content is a formula.

8. An apparatus for improving user experience when reading a bi-directional (BiDi) document, comprising:
a specific text content range receiving module for receiving a range of a specific text content a reading direction of which needs to be indicated in the BiDi document;
a reading direction determining module for determining the reading direction of the specific text content; and
a direction flag displaying module for displaying a direction flag for the specific text content to indicate the reading direction of the specific text content.

9. The apparatus according to claim 8, wherein the direction flag is an arrow and is displayed above, under, or overlapping with the specific text content.

10. The apparatus according to claim 8, wherein the direction flag is displayed when a cursor is moved to a position of the specific text content or when the specific text content is selected.

11. The apparatus according to claim 8, wherein when a cursor is near the specific text content, the direction flag is displayed at the position of the cursor or on a status bar of a document window in which the specific text content is displayed.

12. The apparatus according to claim 8, further comprising:
a direction flag setting module for, before displaying the direction flag, setting and storing at least one attributes for the direction flag, the attribute comprising at least one of: an indication target, appearance, display time and display position.

13. The apparatus according to claim 8, further comprising:
a specific text content range setting module for setting the range of the specific text content the reading direction of which needs to be indicated in the BiDi document, and
a reading direction setting module for setting a reading direction of the specific text content the reading direction of which needs to be indicated in the direction flag.

14. The apparatus according to claim 8, wherein the specific text content is a formula.
